(19) United States
(12) Patent Application Publication
(10) Pub. No.: US 2004/0118643 A1
(43) Pub. Date: Jun. 24, 2004

(54) In wheel brake assembly

(76) Inventor: Benjamin V. Booher, Scottsdale, AZ (US)

Correspondence Address: FRELING E. BAKER, BROWN MARTIN HALLER & MCCLAIM, 1660 UNION STREET, SAN DIEGO, CA, 92101, US

(21) Appl. No.: 10/328,606

(22) Filed: Dec. 23, 2002

(51) Int. Cl. F16D 65/00

(52) U.S. Cl. 188/73.1; 188/18 A

(57) ABSTRACT

A wheel brake assembly, includes a housing adapted for detachably mounting on an end of an axle of a vehicle, a hub mounted on the housing and adapted for mounting a wheel for rotation, a brake disc having an inner diameter and an outer diameter adapted for mounting at its outer diameter on and rotating with the wheel, and at least a stationary component of the brake assembly mounted on the housing and comprising a caliper unit encompassing the disc at the inner diameter and having an actuator for moving brake pads into engagement with opposing surfaces of the disc.

### BACKGROUND OF THE INVENTION

The present invention relates generally to brake assemblies and pertains particularly to improved combination of wheel and brake for large heavy duty trucks and vehicles wherein the brake assembly is as a unit with the wheel.

The brake systems of automotive vehicles such as cars, trucks, tractors and trailers have a friction brake unit associated with each wheel for use in slowing and stopping the vehicle. A friction brake is basically a pair of friction members, one rotating and one stationary, brought into engagement to produce a friction force measured as brake torque for either slowing or stopping the rotating element. Brakes are preferably designed so that the brake torque is somewhat proportional to the input force used to engage the elements and the energy of the rotating member is dissipated in the form of heat.

The rotating element of a brake system is usually a disc or drum made of metal such as a steel alloy, and typically rotates with a wheel or drive axle of the vehicle. The stationary element is usually a composition pad or shoe lining carried by a mechanism mounted to a stationary portion of the vehicle and moveable into and out of engagement with the rotating element. The drum or disc is normally mounted on a on a hub or an axle and rotates with a wheel. The wheel is usually detachably mounted to a hub to which the drum or disc is coupled.

The composition element of a brake unit is designed to wear without undue wear of the metal disc or drum and is normally stationary on an outer end of an axle. The friction or brake unit or assembly is normally mounted or positioned inboard of the wheel and coupled to the axle or a rotatable hub to which the wheel is separately and detachably mounted. Often the wheel is detachably mounted to the drum or a hub that carried the drum or disc.

This inboard mounting of these brake components creates a number of disadvantages. These include difficulty in visually inspecting the components, difficulty in gaining access for maintenance and replacement of components and poor cooling of the components of the assembly. These are disadvantages for most applications and particular disadvantages for certain applications, particularly for heavy duty transport vehicles such as trucks and tractor-trailer rigs. The down time for maintenance and repair of brake systems for these heavy duty vehicles can be costly for the owner operator and for merchants and manufacturers relying on them for transport of goods.

The braking systems for these heavy duty vehicles have massive drums and shoes in order to provide adequate braking for the heavy loads transported. These have to be massive because of the massive loads and because they cannot afford to have frequent and lengthy downtime. The drums or rotor can be an inch or more in thickness even when made from advanced composites and can weigh several pounds. Such drums and rotors also require extended time to bring them up to operating temperature. The friction linings and pads must also be massive in thickness in order to last for any reasonable operating period. Even with such massive brake system, it is often necessary to take costly maintenance or repair stops to rebuild them.

Accordingly, it is desirable that improved brake assemblies, structures and methods of manufacture be available to overcome the above and other problems of the prior art. It is also desirable that unit brake and wheel assemblies be available.

### SUMMARY OF THE INVENTION

It is the primary object of the present invention to provide improved friction brake assemblies, structures and methods that overcome the above problems of the prior art.

Another object of the present invention is to provide improved brake and wheel combination that can be changed as a unit.

Another object of the present invention is to provide improved wheel and brake combination that is simple and inexpensive with self contained energizing means with the entire brake assembly contained within the wheel.

In accordance with a primary aspect of the present invention, a dry couple in wheel brake assembly, comprises a hub for mounting on an axle for rotatably mounting a wheel and at least one component of a brake assembly, a quick connect device for detachably mounting said hub on the axle, a brake assembly having a stationary component mounted on said hub, and a rotating component mounted on the wheel, and a self contained brake actuating system within said brake assembly.

Another aspect of the invention includes improved quick change wheel and brake combination that is simple and inexpensive with self contained energizing means with the entire brake assembly contained within the wheel.

### BRIEF DESCRIPTION OF THE DRAWING

The above and other objects, nature, goals, and advantages of the invention will become more apparent to those skilled in the art after considering the following detailed description when read in connection with the accompanying drawing, illustrating by way of examples the principles of the invention, in which like reference numerals identify like elements throughout wherein:

FIG. 1 is a perspective view with portions broken away of a wheel and brake assembly in accordance with one preferred embodiment of the invention;

FIG. 2 is an end elevation view of the brake assembly of the embodiment of FIG. 1;

FIG. 3 is a side elevation view of the brake assembly of the embodiment of FIG. 2;

FIG. 4 is an schematic elevation view of the brake and air actuation system; and

FIG. 5 is an schematic elevation view of or an alternative brake and air actuation system; and

FIG. 6 is an elevation sectional view showing a drum mounted rotor disc.

It will be appreciated that some or all of the Figures are schematic representations for purposes of illustration and do not necessarily depict the actual relative sizes or locations of the elements shown.

### DETAILED DESCRIPTION OF THE PREFERRED EMBODIMENTS

In the following paragraphs, the present invention will be described in detail by way of example with reference to the attached drawings. In the description, the parts and components of the present invention which are the same will be referred to by the same or similar reference symbols.

Definitions

Unless defined otherwise, all technical and scientific terms used herein have the same meaning as is commonly understood by one of skill in the art to which this invention belongs. In event the definition in this section is not consistent with definitions elsewhere, the definitions set forth in this section will control.

As used herein, dry coupling means an operative coupling between two systems such as hydraulic to hydraulic, air to hydraulic or other without a mingling or transfer of fluid. In the instant system a master hydraulic system actuates a slave hydraulic system through a disconnectable mechanical coupling.

As used herein, self contained actuating system means a complete actuating system requiring only an input movement for actuation. In the case of a hydraulic system it means a closed system having its own separate hydraulic fluid, an actuation or master cylinder and an actuated or slave cylinder.

General

Throughout this description, the preferred embodiment and examples shown should be considered as exemplars, rather than as limitations on the present invention.

The present invention is directed to improvements in the construction, location, mounting and operation of brake systems for automotive vehicles such as heavy duty trucks and other vehicles. The present invention also provides improvements in the construction and mounting of wheels and combined wheel and brake assemblies. More specifically the present invention provides combination wheel and brake assemblies wherein the brake assembly is contained within and removable with the wheel as a unit. The wheel and brake assembly may be provided as original equipment on the vehicle, or it may be retrofitted to existing vehicles. In a retrofit situation it would be substituted for the usual plate or flange on the end of an axle on which the brake shoes and actuator mechanism is mounted.

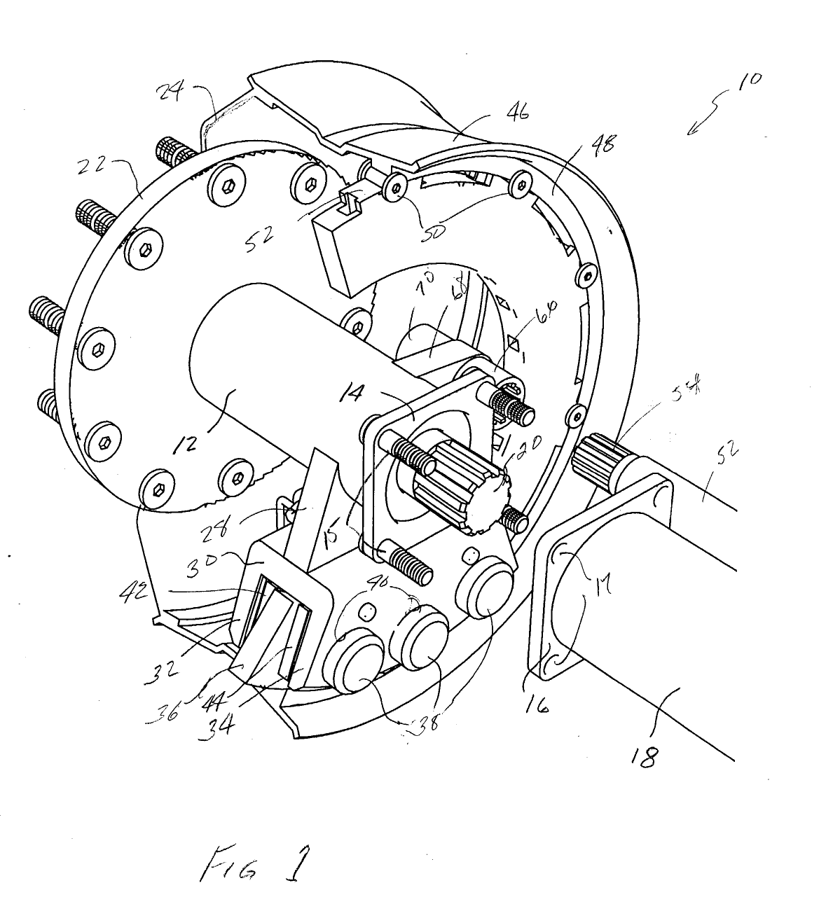

Referring to FIGS. 1-3 of the drawings, there is illustrated an exemplary embodiment of a combination wheel and) brake system in accordance with one embodiment of the invention. The illustrated system, designated generally by the numeral 10, is for a drive wheel of a vehicle and is illustrated and described as applied to a heavy duty truck or tractor. The illustrated system comprises a removable axle end or extension unit in the form of a sleeve or cylindrical housing 12 which has a flange 14 at one end with bolts adapted to detachably attach to a flange 16 on an outer end of a standard drive axle 18. The housing replaces the typical mounting plate attached to the end of an axle on which the brake components are normally mounted. A stub axle 20 is rotatably mounted in the housing or extension 12 and has a wheel mounting flange 22 at an outer end to detachably mount one or more wheels 24. The shaft 20 is mounted for rotation in suitable bearings (not shown), and has a splined inner end coupling 26 for coupling to a splined end or coupling [28] of a rotating drive axle [30] (not shown) within axle tube 18. Other suitable shaft connections or couplings may be employed.

The present system employs a disc brake system having its major stationary components mounted on and carried by the axle housing. The axle housing or assembly carries a caliper unit that cooperates with a disc mounted to a wheel rim. This system replaces the usual brake drum and shoe type brake system that is normally mounted on the end of an existing drive axle of a truck or tractor vehicle. In the illustrated embodiment the stationary or caliper portion of the brake assembly includes central support member 28 which is attached to and extends around and radially outward from the outer surface of the wall of the axle housing or sleeve 12.

A generally U shaped channel or bracket 30 is attached to and extends along an outer edge of the support member 30 and has opposed walls 32 and 34 that extend around and to opposite sides of an annular brake disc 36 that is attached to the interior or a wheel rim. The caliper unit has at least one and preferably multiple cylinders 38 mounted in one wall 34 of the channel. The cylinders may be air or hydraulic and function to apply one or more friction pads to the opposing surfaces of the brake disc. The brake assembly may have one or more caliper assemblies operating simultaneously, alternately, or selectively. For example, one or two more caliper units as illustrated may be spaced circumferentially about the axle extension 12 and the disc. The actuating system may be programmed so that the units all operate at the same time, in sequence one at a time or in any other selected combination. The caliper units may also be programmed to separately operate in response to different temperatures so that one operates when the brakes are cold and another when the brakes are hot. Each caliper actuator unit preferably has multiple cylinders that mount in circular bores or recesses 40 in at least one side wall 34 of bracket 30.

The cylinders are preferably of standard known construction with a piston within a cylinder and will not be described in detail. Each caliper actuator unit has a brake pad 42 and 44 disposed adjacent to each opposite surface of brake disc 36. Brake disc 36 is mounted to an annular rim of a wheel for mounting a tire or it may be mounted to a separate drum. In the illustrated embodiment, the brake disc 36 is mounted on the inside of a wheel rim 46 on which a tire is to be mounted. The wheel 24 is provided with an inner rim or flange 48 to which the disc 34 is detachably attached by means of bolts 50. Bolts 50 extend through semi-circular bores formed is both the flange and the disc or a mounting block 52 extending into slots formed in the outer diameter of the disc. This provides a floating mount of the disc to the wheel to enable it to move to accommodate the caliper units. The disc may also be attached to a drum or other carrier attached or coupled to the axle or to the wheel as will be subsequently discussed. It will be appreciated that the outward opening or the calipers enable larger diameter discs to be employed. This provides more disc surface for braking. It also provided a greater lever arm for the braking action and thereby a greater force for a given brake pressure. In addition it enables the use of a simpler structure than conventional disc brake arrangements. In summary the wheel and brake assembly are both mounted on a common removable housing or sleeve. This enables the entire brake assembly for any wheel to be removed and replaced easily and quickly so that the truck can be put quickly back in service.

As discussed above the illustrated brake assembly is designed to replace or substitute for existing drum and shoe units currently widely used on trucks and tractor trailer vehicles. As shown in FIG. 1, the brake and wheel assembly mounts pm a flange 16 on the end of an axle housing of a heavy duty vehicle. The vehicle is equipped with a typical air operated brake system wherein an air cylinder 72 (FIG. 4) is connected to a cam shaft 52 that is normally connected to a cam that operates through a linkage to apply the brakes. The shaft is formed with a splined connection at the outer end that connects the shaft to the cam and transmits torque thereto. Applicant has designed the present system to accommodate existing structure. To this end, the present system is provided with a self contained hydraulic system that is operated by the conventional air brake system through the cam shaft.

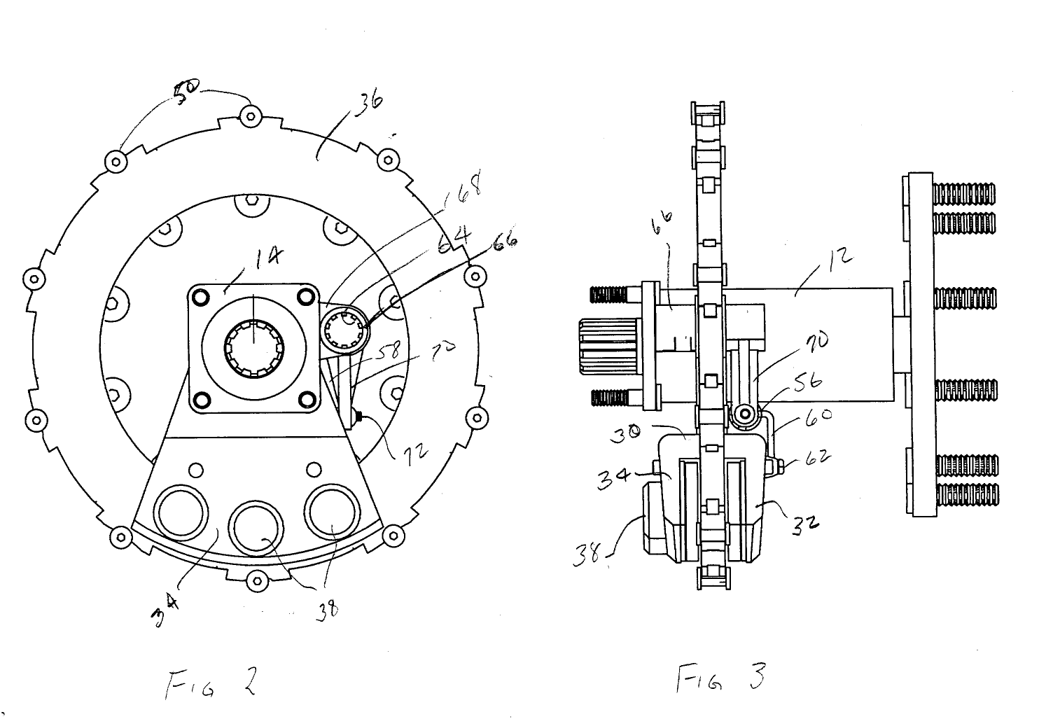

The brake operating system for each wheel of the present system comprises a hydraulic master cylinder 56 mounted on an arm or bracket 58 attached to the housing 12 as seen in FIG. 3. The hydraulic cylinder communicates fluid by way of a hydraulic line 60 through a coupling 62 to the cylinders 38 of the caliper unit. Hydraulic cylinder 56 is actuated by the vehicle air brake system by cam shaft 52 connected by splines to splines 64 in a shaft 66 rotatably mounted for rotation by suitable bearings not shown in a bore in the outer end of an arm 68 mounted on housing 12. An arm 70 is attached to and extends outward from shaft 66 and is connected by suitable connecting means at 72 to a piston in cylinder 56 for operating the piston to pressurize the caliper cylinders to actuate the brakes.

A as illustrated in FIG. 1, brake disc 36 is detachably mounted to the inner diameter of the lip 48 of the wheel rim by studs 50 extending through bores formed as half circles in each of lip 48 and disc 36 respectively. This form of mounting establishes a floating mounting of the disc to the wheel rim enabling it to shift to accommodate the caliper unit. This disc is the rotating or movable portion of the brake assembly and can be constructed of any suitable material such as metal or metal alloys, composite or combinations of metals and composites or coating materials of composites or ceramics on metals. The rotor can be constructed as solid, vented or laminated. The disc may also be mounted within a drum that will be mounted inside the wheels.

As discussed above, the illustrated brake assembly is hydraulically actuated in each wheel assembly with a closed system that is essentially self contained. The hydraulic system has a master cylinder including a cylinder 56 with a piston disposed centrally of the cylinder and connected by a conduit and passage (not shown) in the caliper channel 30 to the cylinders in the caliper units. The master cylinder may be actuated by any suitable vehicle mounted actuator system which may be air, hydraulic, electromechanical, and mechanical or the like. The caliper cylinders 38 are slave cylinders to the master cylinder and respond to movement of the master cylinder and the pressurized hydraulic fluid to move and actuate or apply the brakes. The master cylinder may be actuated or moved by any suitable means such as a mechanical plunger, or a hydraulic actuated plunger or an electrically actuated plunger.

The illustrated embodiment is adapted to mount to a drive axle of a vehicle chassis. It will be appreciated that other it may be applied to non driving axles with less complicated structures. The just described wheel brake combination is for a drive wheel. Minor modifications would be necessary for application to a non-drive wheel as will be described hereinafter. The brake assembly is shown on the inside of the web or spokes of the wheel and recessed within the wheel. This arrangement provides reasonably easy access to the brakes for inspection and for maintenance or repairs. The disc may be constructed of any suitable material such as steel and alloys thereof, other metals and their alloys, ceramics, composites etc. The disc may be made of light central core with coatings or laminates of other materials such as metals, ceramics, composites etc.

The brake unit is dry coupled to the vehicle brake actuating system so that when the wheel assembly is mounted on the end of the axle the vehicle system and the wheel system are coupled for operation. When the wheel assembly is removed, the systems are un-coupled with both the wheel actuating system and the vehicle actuating system remaining in tact. The just described wheel brake combination is for a drive wheel. The brake assembly is shown mounted on the inside of the web or spokes of the wheel and recessed within the wheel. This arrangement enables quick removal of the entire wheel and brake assembly and provides easy access to the brakes for inspection and for maintenance or repairs.

The fluid in the system can be re-circulated by providing a series of one way valves that allows the fluid in the caliper pistons to re-cycle within the closed loop of the in wheel system. This extends the life of the fluid. In addition, the fluid can be cooled by adding fins to one or more of the lines of the system.

Referring to FIG. 4, a schematic representation of the operating system of the just described system is illustrated. An air cylinder 72 is mounted on axle 20 and connected to cam shaft 52 which connects to the hydraulic system of the wheel brake unit. Air from a source on the vehicle is supplied to the air cylinder when the vehicle brakes are applied to actuate and apply the brakes of each wheel unit.

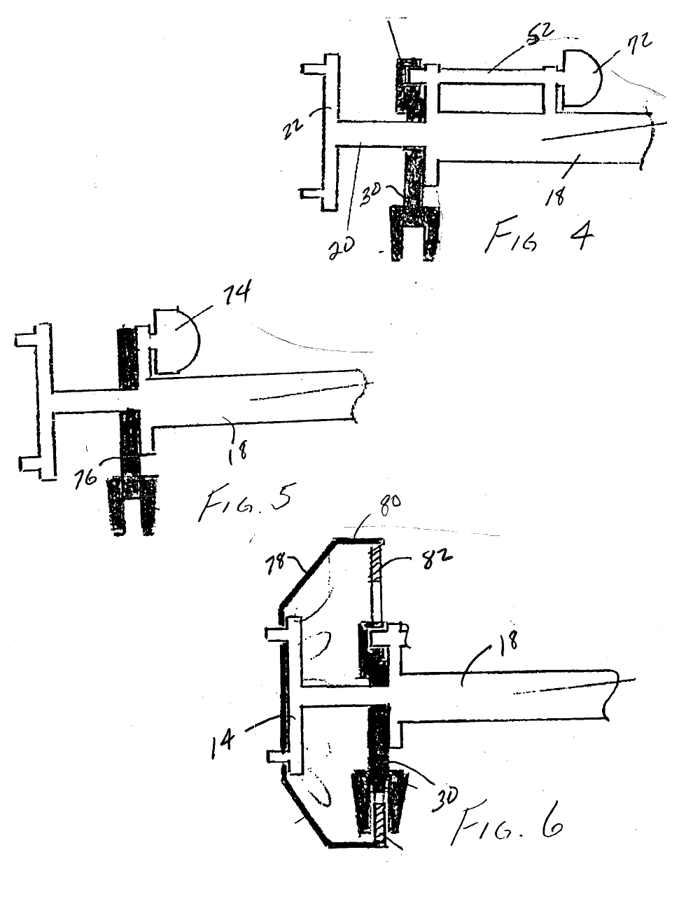

Referring to FIG. 5, a schematic representation of an alternate operating system for the just described system is illustrated. An air cylinder 74 is mounted preferably on plate or flanges 14 of the axle 20 and connected to actuate the calipers directly through a linkage system 76, not shown in detail. Air from a source on the vehicle can be connected by a quick connect line and supplied to the air cylinder when the vehicle brakes are applied to actuate and apply the brakes of each wheel unit.

The present invention can also be implemented by any number of actuating systems including hydraulic, mechanical, electromechanical and hydro mechanical actuating systems. Such a system could be electrically actuated with either electrical or electronic controls, either hard wired or wireless, for controlling the actuation. These are typically referred to as brake-by-wire systems and have some advantages and some disadvantages when compared to hydraulic systems. They can be lighter in weight and more controllable when such functionality as ABS, TCS, and ASMS etc. are embodied. They are also more environmentally friendly than hydraulic systems in that they are not prone to leak contaminating fluids. One of the disadvantages is the varying efficiency of the actuator in changing rough environmental conditions and wear. Another disadvantage is that expensive sensitive sensors are required for numerous parameters including force or torque. An electrical brake system would use calipers with either a solenoid or a toque motor in place of the hydraulic cylinders to apply the brake force or pressure. The force or pressure would be applied to pads that engage a rotor or disc as in the hydraulic system.

FIG. 6 illustrates an alternate mounting of the disc as previously mentioned. In this embodiment, a drum 78 is adapted to mount to the wheel mounting hub 14 and includes an annular rim 80 having an inner surface to which a disc 82 is mounted. Disc 82 is engaged by the same outwardly opening calipers as in prior embodiments. Disc 82 may be permanently or detachably mounted to the drum as desired. This drum arrangement enables a more flexible selection of and accommodation of different wheel sizes and hardware geometry of various vehicles. It eliminates the need to modify wheels to accommodate the disc. Drum 78 is preferably slotted as shown to provide for air flow.

In operation, when a brake assembly of any one or more wheels of a vehicle is in need of repair, the entire brake and wheel assembly is removed by removing the nuts from four bolts 15 at the end of the axle. The entire wheel and brake assembly is pulled axially off the end of the axle. This simultaneously disconnects the actuating system leaving both portions of the actuating system in tact. A new or reconditioned wheel and brake assembly is selected and mounted on the end of the axle in a reverse action of the above described action. The unit is properly aligned and simply moved axially toward the end of the axle mating spline coupling on the end of shaft 2o with splines on the drive axle, mating splines on the cam shaft with splines on shaft 60 and bolts 15 with holes 17. nuts are then placed o bolts 15 and tightened down. The actuating system is automatically and simultaneously connected in this operation.

While I have illustrated and described my invention by means of specific embodiments, it is to be understood that numerous changes, modifications and applications may be made therein without departing from the spirit and the scope of the invention as shown in the appended claims. For example, while the invention has been described in application to heavy duty vehicles such as trucks and tractor trailer combinations, may also b applied to light trucks, passenger automotive vehicles, racing cars, and to numerous other systems such as busses, railway cars, trolleys, aircraft and the like. The caliper assembly can be mounted directly to the typical end plate on a typical axle or it can be incorporated into a replaceable end plate.

I claim:

1. A wheel brake assembly, comprising:
a housing adapted for detachably mounting on an end of an axle of a vehicle;
a hub mounted on said housing and adapted for mounting a wheel for rotation;
a brake disc having an inner diameter and an outer diameter adapted for mounting at its outer diameter on and rotating with the wheel; and
at least a stationary component of a brake assembly mounted on said housing and comprising a caliper unit encompassing said disc at the inner diameter and having actuator means for moving brake pads into engagement with opposing surface of said disc.

2. A brake assembly according to claim 1 wherein said actuator means comprises at least one hydraulic cylinder on at least one side of said disc.

3. A brake assembly according to claim 1 wherein said disc is detachably mounted to an inner lip within an inner surface of the rim of the wheel.

4.

4. A brake assembly according to claim 1 wherein said actuator means comprises a plurality of hydraulic cylinders on at least one side of said disc.

5. A brake assembly according to claim 1 wherein:
said stationary component comprises a support member mounted to the housing and extending to a side of the axis of said axle, and
said caliper assembly comprises an elongated curved channel member opening radially outward mounted on said support member.

6. A brake assembly according to claim 4 wherein said caliper unit comprises an elongated U shaped member defining a pair arms adapted to extend to opposite sides of a disc.

7. A brake assembly according to claim 6 wherein said caliper assembly comprises a self contained hydraulic actuating system which comprises:
a cylinder carried by said support housing having a piston mounted therein;
a plurality of cylinders on each of said caliper units; and
hydraulic fluid passages communicating between said cylinder and said pistons.

8. A brake assembly according to claim 7 wherein said piston is positioned for connection and actuation when said housing is detachably mounted on an axle of a vehicle.

9. A brake assembly according to claim 4 wherein said actuator comprises:
a U shaped support member having arms extending on opposite sides of said disc; and.
a cylinder on at least one of said arms for biasing a friction pad into engagement with a surface of said disc.

10. A brake assembly according to claim 1 wherein said brake actuator comprises:
a support member having portions extending on opposite sides of said disc;
at least one brake pad positioned on each side of said disc mounted on said support member; and,
an electric motor for biasing each of said brake pads into engagement with a surface of said disc.

11. A combined wheel and brake assembly, comprising:
a housing adapted for detachably mounting on an end of an axle of a vehicle;
a hub mounted for rotation on said housing and adapted to be driven by said axle;
a wheel mounted for rotation on said hub:
at least a stationary component of a brake assembly mounted on said housing;
a rotating component of a brake assembly detachably mounted on said hub and rotatable with said wheel; and
a self contained brake actuation system mounted on said housing for actuating said brake assembly.

12. A brake assembly according to claim 11 wherein said rotating component is a disc detachably mounted within an inner portion of an annular rim.

13. A brake assembly according to claim 12 wherein:
said stationary component is a caliper assembly including a support member mounted to the hub and extending to a side of the axis of said axle, and
a caliper unit mounted on said support member.

14. A brake assembly according to claim 13 wherein said caliper assembly comprises a self contained hydraulic actuating system which comprises:
a master cylinder on said support housing having a piston mounted therein;
a plurality of pistons in each of said caliper units; and
hydraulic fluid passages communicating between said cylinder and said pistons.

15. A brake assembly according to claim 11 wherein said brake actuator comprises:
a support member having portions extending on opposite sides of said disc;
at least one brake pad carried by said support member and positioned on each side of said disc; and,
an electric motor for biasing each of said brake pad into engagement with a surface of said disc.

16. A combined wheel and brake assembly, comprising:
a hub adapted for detachably mounting on a suspension of a vehicle;
a device for detachably retaining said hub on said suspension;
a wheel having a rim mounted for rotation on said hub:
at least one stationary component of a brake system mounted on said hub;
at least one rotating component of a brake system detachably mounted on the rim of said wheel; and
a self contained brake actuator mounted on said hub for actuating said brake assembly.

17. A process according to claim 16 wherein
said stationary component is a caliper assembly including a support member mounted to the hub and extending to a side of the axis of said axle, and
a caliper unit mounted on said support member.

18. A brake assembly according to claim 17 wherein said rotating component is a disc detachably mounted within an inner portion of the wheel rim.

19. A brake assembly according to claim 18 wherein said brake actuator comprises:
a support member having portions extending on opposite sides of said disc;
at least one brake pad carried by said support member and positioned on each side of said disc; and,
an electric motor for biasing each of said brake pad into engagement with a surface of said disc.

20. A brake assembly according to claim 15 wherein said caliper assembly comprises a self contained hydraulic actuating system which comprises:
a cylinder in said support housing having a free piston mounted therein;
a plurality of pistons in each of said caliper units; and
hydraulic fluid passages communicating between said cylinder and said pistons.
